(19) United States
(12) Patent Application Publication
(10) Pub. No.: US 2009/0004072 A1
(43) Pub. Date: Jan. 1, 2009

(54) Ceramic Chemical Reaction Device Capable of Decomposing Solid Carbon

(75) Inventors: Koichi Hamamoto, Aichi (JP); Yoshinobu Fujishiro, Aichi (JP); Masanobu Awano, Aichi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Nat. Ins. of Adv. Industrial Sci. and Tech, Tokyo (JP)

(21) Appl. No.: 11/814,419

(22) PCT Filed: Jan. 23, 2006
(86) PCT No.: PCT/JP2006/300968

§ 371 Date: Jul. 20, 2007

(30) Foreign Application Priority Data
Jan. 24, 2005 (JP) 2005-014927

(51) Int. Cl. B01D 53/94

(52) U.S. Cl. 422/180

(57) ABSTRACT

The present invention relates to a ceramic chemical reaction device capable of decomposing solid carbon, and provides a chemical reactor comprising a chemical reaction device that has an ion-conducting ceramic material and a chemical reaction structure composed of a catalyst electrode that is formed on the ceramic material and can electrochemically remove solid carbon (PM) by direct oxidation, a cathode, a solid electrolyte, and an anode, and thereby solid carbon (PM) is directly oxidized and removed on the anode surface by a reaction of C+2O²⁻→CO₂ by using oxygen ions supplied via the solid electrolyte.

### TECHNICAL FIELD

The present invention relates to a ceramic chemical reaction device capable of decomposing solid carbon, and more particularly to a ceramic chemical reactor in which carbon-containing particulate matter (PM) and the like can be directly and continuously decomposed by creating a flow of electricity with an electrode formed on an ion-conducting ceramic material, and also to a composite-type oxidation-reduction ceramic chemical reactor having a chemical reaction function of pulling out oxygen from nitrogen oxides present in the air and electrochemically oxidizing gaseous hydrocarbon compounds and the like via an oxygen ion-conducting ceramics, a material of the electrodes of the reactor, system comprising same, and application thereof. In accordance with the present invention, because solid carbon particulate matter, hydrocarbons, or nitrogen oxides can be electrochemically decomposed, the invention can be advantageously applied to purifying high-temperature exhaust gases such as automobile exhaust gases and volatile organic compounds (VOC).

### BACKGROUND ART

In our environment hazardous organic substances generated by human activity are released, and removal thereof is an important problem from the standpoint of improving safety. In particular, in recent years, a sick house illness caused by the release of organic solvents contained in construction materials or the like has become a problem. Further, removal of nitrogen oxides, carbon-containing particles (PM: solid carbon and hydrocarbons containing four or more carbon atoms that adhere to solid carbon), hydrocarbons, and carbon monoxide contained in gases discharged in energy production, such as power generation by combustion of petroleum fuels, and in exhaust gases of automobiles, in particular in exhaust gases of diesel engines generated by combustion of heavy oils, is one of technological tasks that requires urgent solution in order to reduce the amount of hazardous substances in the atmosphere. For this purpose, solid carbon, nitrogen oxides, and hydrocarbons contained in the released exhaust gases have to be removed at the same time.

In this case, it is necessary that different chemical reactions such as reduction and decomposition of nitrogen oxides and oxidation of incompletely combusted hydrocarbons or solid carbon and carbon monoxide could be advanced simultaneously and with good efficiency. Within a framework of existing technology, gaseous hazardous substances such as hydrocarbons, carbon monoxide, and nitrogen oxides are decomposed simultaneously using active catalysts such as metal ternary catalysts. However, in lean burn engines, a reduction reaction does not proceed due to air/fuel ratio control. The resultant problem is that nitrogen oxides are difficult to purify. Accordingly, these substances are decomposed in a batch mode by reaction atmosphere control using an oxidation catalyst and a ternary catalyst. Further, a technology is needed that will enable the reduction and decomposition of nitrogen oxides with a high efficiency even under conditions with a high oxygen concentration. When solid carbon such as PM is co-present, chemical decomposition of this component is difficult and it is removed physically, e.g., with a filter.

However, when a filter or the like is used, it has to be replaced and cleaned periodically. Therefore, it is desirable that complete and continuous oxidation and decomposition of solid carbon, which is hardly combustible, and hydrocarbons of a high molecular weight proceed simultaneously with the decomposition of nitrogen oxides. A method of controlling chemical reactions electrochemically is one of means for simultaneously performing oxidation decomposition and reduction decomposition. In particular reduction decomposition can be expected to be enhanced electrochemically by using an electrochemical cell such as an ion conducting ceramic cell. Furthermore, when reduction is enhanced by oxygen pull-in in such ion conducting ceramic cells active oxygen is released at the same time. Therefore causing oxidation and combustion of solid carbon such as PM by a mechanism using the enhancement of reduction and release of active oxygen can be expected to enable the simultaneous continuous removal of hazardous substances present in exhaust gas. Furthermore, because exhaust gas has a high temperature, there is a need for development and use of materials e.g. ceramic materials that can operate with good stability under such conditions.

Usually by causing an electric current to flow to an oxygen ion-conducting ceramic oxygen is ionized on an electrode by supplied electrons and, due to conduction of the ions, electrons and oxygen are released at the counter electrode and an electric current flows. In this case, a system in which electrochemical action and catalytic action coexist can be formed by disposing a material enhancing a reduction reaction and a material enhancing an oxidation reaction as electrode materials. However properties of the system vary significantly depending on the electrode material and structure thereof. In the usual structure, oxygen molecules serving as a carrier source are directly pulled in and discharged. As a result energy is used on the motion of oxygen that is not directly related to the target oxygen decomposition of solid carbon, carbon monoxide, and hydrocarbons and reduction decomposition of nitrogen oxides.

As a result, the total energy efficiency decreases. Accordingly it is necessary to create a structure that decreases power used for transferring oxygen that does not contribute to the reaction and to advance the reaction with good efficiency at a low electric current. Further, in the oxidation of solid carbon such as PM, it is necessary to arrange a material serving as an oxidation catalyst that uses the released oxygen and enhances the oxidation or a material having a function of rapidly accelerating the oxidation reaction, such as active oxygen or radical-generating agent. In the reduction of nitrogen oxides, it is necessary that a material of a transition metal kind that acts as a reduction catalyst be present in the vicinity of electrodes to decompose harmless nitrogen and oxygen. Furthermore, in order to decompose and remove PM or nitrogen oxides in a continuous mode under high-temperature conditions such as those of exhaust gas, it is necessary to produce a ceramic reaction device having the aforementioned reaction enhancing materials arranged therein and provide a structure that can supply electricity and can be actuated with good efficiency.

A variety of technologies relating to electrochemical reactors and decomposition of solid carbon have heretofore been suggested. Thus, in relation to electrochemical reactors, for example, a chemical reactor (Japanese Patent Application Laid-open NO. 2003-033648), a system for removing nitrogen oxide Japanese Patent Application Laid-open No. 2004-041965), a nitrogen oxide removal catalyst (Japanese Patent Application Laid-open No. 2004-033648), an electrode material for a chemical reactor (Japanese Patent Application Laid-open No. 2003-265950), a chemical reactor for nitrogen oxide purification (Japanese Patent Application Laid-open No. 2004-041975), a chemical reaction system of an electrochemical cell type (Japanese Patent Application Laid-open No. 2004-058028), a chemical reaction system of electrochemical type and a method for activation thereof (Japanese Patent Application Laid-open No. 2004-058029), and catalytic reactions (U.S. Pat. No. 4,902,487, Japanese Examined Patent Application No. H7-106290, and Environmental Catalysts, Nippon Hyomen Kagakukai, Published by Kyoritsu Shuppan KK, p. 167 (1997)) have been suggested. In relation to solid carbon decomposition, for example, an exhaust gas treatment device (Japanese Patent Applications Laid-open No. 2003-135928 and 2003-126654) and a diesel automobile exhaust fume removal device (Japanese Patent Application Laid-open No. 2004-162681) have been suggested.

### DISCLOSURE OF THE INVENTION

With the foregoing in view and with consideration for the above-described prior art, the inventors have conducted a comprehensive study aimed at the development of a ceramic chemical reaction device that can directly and continuously decompose, e.g. carbon-containing particles (PM) such as dust by an electrochemical process. The results obtained demonstrate that the desired object can be attained by passing electric current to a single crystal or polycrystalline material in which dissimilar elements (rare earth metals, alkaline earth metals, etch) are dissolved in the form of solid solution in a metal oxide such as zirconium oxide and which demonstrate electric conductivity based on oxygen ion conductivity. This finding in combination with the results of subsequent research led to the creation of the present invention.

It is an object of the present invention to provide a ceramic chemical reaction device capable of decomposing solid carbon. Another object of the present invention is to provide a ceramic reactor that directly and continuously decomposes carbon-containing particulate matter (PM) by causing an electric current with electrodes formed on an ion conducting ceramic material. Yet another object of the present invention is to provide a composite oxidation-reduction ceramic reactor that can pull out oxygen from, e.g. nitrogen oxides present in the air and reduction decompose them and, at the same times can pump oxygen ions via an oxygen ion-conducting ceramic and oxidize gaseous hydrocarbon compounds.

The present invention that attains the aforementioned object is configured by the following technological means.

(1) A chemical reaction device having a chemical reaction mechanism comprising an ion-conducting ceramic material and a catalyst electrode formed on the ceramic material and capable of directly oxidizing and removing solid carbon (PM) electrochemically.

(2) The chemical reaction device according to (1) above, wherein the ion-conducting ceramic material is a single-crystal or polycrystalline material in which a dissimilar element is solid-solution dissolved in a metal oxide.

(3) The chemical reaction device according to (2) above, wherein the metal oxide is zirconium oxide, cerium oxide, gallium oxide, or bismuth oxide, and the dissimilar element is a rare earth metal or an alkaline earth metal.

(4) The chemical reaction device according to (1) above, wherein the catalyst electrode comprises an oxide or a noble metal conductive material.

(5) The chemical reaction device according to (1) above, having an action of directly oxidizing solid carbon (PM) into CO₂ and removing the same on the catalyst electrode.

(6) The chemical reaction device according to (1) above, wherein an oxidizing agent and calcium aluminate are used as the catalyst electrode.

(7) The chemical reaction device according to (1) above, wherein electrodes are provided in two or more places and an electric current is supplied thereto.

(8) A chemical reaction device that is a chemical reactor comprising a cathodes a solid electrolyte, and an anode, wherein solid carbon (PM) is directly oxidized and removed by a reaction

C+2O²⁻→CO₂+4e⁻

by using oxygen ion supplied via the solid electrolyte on the anode surface.

(9) The chemical reaction device according to (8) above, wherein a reduction reaction proceeds on the cathode, and an oxidation reaction proceeds on the anode.

(10) The chemical reaction device according to (8) above, wherein on the cathode a nitrogen oxide and/or carbon dioxide present in the air is reduction decomposed oxygen ions thus generated are supplied to the anode via the solid electrode, and hydrocarbons, carbon monoxide and/or solid carbon are directly electrochemically oxidized on the anode.

(11) The chemical reaction device according to (1) or (8) above, which is a chemical reaction device for exhaust gas purification.

(12) The chemical reaction device according to (1) or (8) above, which is a chemical reaction device for purification volatile organic compounds.

(13) An exhaust gas purification device comprising the chemical reaction device according to (1) or (8) above and having a function of decomposing and removing hazardous substances by using a reduction reaction and/or an oxidation reaction of the chemical reaction device.

(14) A gas-phase purification device comprising the chemical reaction device according to (1) or (8) above and having a function of decomposing and removing volatile organic device.

(15) An exhaust gas purification device comprising a plurality of chemical reaction devices according to (1) or (8) above in an exhaust gas channel.

The present invention will be described below in greater detail.

The chemical reactor device in accordance with the present invention has a chemical reaction structure in which a catalyst electrode capable of directly oxidizing and removing solid carbon (PM) electrochemically is formed on an ion-conducting ceramic material. The chemical reaction device in accordance with the present invention preferably comprises, for example, a cathode electrode and an anode electrode on both surfaces of a solid electrolyte, has a structure that supplies electric current to the electrodes, and has a function of supplying oxygen ions generated by reduction reaction at the cathode to the anode via the solid electrolyte and converting the solid carbon into CO₂ and removing it by direct oxidation reaction on the anode. However, the chemical reaction device in accordance with the present invention is not limited to the above-described configuration. For example, any device can be used as the chemical reaction device in accordance with the present invention, provided that the device has a chemical reaction structure in which a catalyst electrode capable of directly oxidizing and removing solid carbon (PM) electrochemically is formed on an ion conducting ceramic material.

In accordance with the present invention, preferred examples of ion-conducting ceramic materials include single-crystal or polycrystalline materials in which a dissimilar element is solid-solution dissolved in a metal oxide such as zirconium oxide, cerium oxide, gallium oxide, and bismuth oxide and which demonstrates electric conductivity based on oxygen ion conductivity, and examples of dissimilar element include rare earth metals and alkaline earth metals. However, these examples are not limiting and materials and elements demonstrating similar effect can be similarly used. Further, examples of electrode materials include oxide materials such as nickel oxide, cobalt oxide, copper oxide, iron oxide, manganese oxide, calcium aluminate (CaₓAl_{y}O_{z}) and titanium oxide, and noble metal materials such as platinum, gold, and silver. However, these examples are not limiting and materials demonstrating similar effect can be similarly used.

For example, the electrode materials are formed to have a structure in which conductive materials are coated and/or baked in two or more places and also formed to have a structure in which an electric current is caused to flow with these materials serving as electrodes. The specific structure can be arbitrarily designed according to the application objects side, and type of the chemical reaction device. For example, in accordance with the present invention, a chemical reaction device can be constructed that has a structure such that a catalyst electrode is formed on the ion conductive ceramic material and the direction oxidation reaction of solid carbon is performed on the surface of the catalyst electrode, or a chemical reaction device can be constructed that has a structure such that cathode and anode electrodes are attached to both sides of a solid electrolyte, a reduction reaction is performed on the cathode, the generated oxygen ions are supplied to the anode via the solid electrolyte, and an oxidation reaction in which solid carbon is directly oxidized is conducted on the anode. In accordance with the present invention, specific structures of these chemical reaction devices can be arbitrarily designed according to the application object, side, and type of the chemical reaction device.

In accordance with the present invention for example, when a chemical reaction device comprising a cathode, a solid electrode, and an anode is constructed, a reduction reaction can be induced on the cathode by supplying an electric current to the chemical reaction device and, at the same time, an oxidation reaction can be conducted on the anode by using oxygen ions generated by the reduction reaction. Therefore, solid carbon can be directly oxidized and removed electrochemically on the anode surface. The chemical reaction device in accordance with the present invention for example, can be advantageously used for removing hazardous substances such as nitrogen oxides and solid carbon that are present in exhaust gases. In this case, nitrogen oxides, carbon dioxide, etc., contained in the exhaust gas are reduction decomposed on the cathode, the generated oxygen ions are supplied to the anode via the ion-conducting ceramic material of solid electrolyte, and carbon-containing particles (PM) hydrocarbons, and carbon monoxide can be directly and continuously oxidized and removed electrochemically by using the oxygen ions on the anode.

Calcium aluminates such as Ca₁₂Al₁₄O₃₃ have recently been reported to generate active oxygen radicals in electrolysis, and because these materials demonstrate a strong oxidation capacity, they are expected to promote oxidation reactions by the generated active oxygen radicals even in solid carbon. However, examples of decomposing solid carbon such as PM by using these materials have not been reported. In accordance with the present invention, a reactor capable of effectively decomposing solid carbon such as PM in a continuous mode can be produced by combining such a material that enhances solid oxidation by electrolytic control and an oxygen ion conducting ceramic material in which oxygen ions can move and which releases oxygen. At the same time, oxygen intake (oxygen absorption ability) into the oxygen ion conductor can be used to oxygen out from nitrogen oxides and perform safe reduction and decomposition into nitrogen.

The effective reduction reaction can proceed in this case when a reducible transition metal oxide such as nickel oxide or copper oxide that selectively enhances the reduction reaction is also present. Materials that are expected to find application in fuel cells for high-temperature use, such as zirconium oxide, cerium oxides gallium oxide, and bismuth oxide are preferred as the oxygen on conductors for high-temperature use. The target solid carbon material and gaseous hazardous substances (nitrogen oxides and the like can be decomposed and removed simultaneously and continuously by constructing a reactor equipped with a film structure that is dense enough to be naturally impermeable to gases such as oxygen and in which the aforementioned materials are effectively disposed via the film structure.

In accordance with the present invention, a chemical reaction device can be advantageously constructed, for example, by forming an electrode material such as platinum and a catalyst material such as calcium aluminate, e.g. Ca₁₂Al₁₄O₃₃, and nickel oxide on the surface of an oxygen ion conducting ceramic such as zirconium oxide and cerium oxide. By supplying a carbon powder as a solid carbon source to the ceramic chemical reaction device, heating under high-temperature conditions preventing autonomous combustion, and supplying electricity, it is possible to burn carbon electrochemically in a continuous mode with oxygen supplied from the ceramic chemical reaction device. Nitrogen oxides that are present at the same time as the carbon source in the ceramic chemical reaction device can be also decomposed. In addition, hydrocarbons present as gas components can be also continuously decomposed in the ceramic chemical reaction device.

In accordance with the present invention, a chemical reactor comprising a cathode, a solid electrolyte, and an anode, wherein on the cathode nitrogen oxide and/or carbon dioxide present in the air is reduction decomposed and the generated oxygen tons are supplied to the anode via the solid electrode, can be advantageously used. In this case, no specific limitation is placed on the structure and shape of the chemical reactor, and any chemical reactor can be used, provided that it has the aforementioned functions. For example, in a chemical reactor for performing a chemical reaction of a substance to be treated or an energy conversion reaction, a chemical reaction unit can be formed by combining fine particles of a transition metal, an ion conductor having an oxygen deficiency-concentration portion, and an electron conductor, this chemical reaction unit having as “basic units”: (1) a reduction phase comprising fine particles of a transition metal that serve as a reaction field; (2) a space for introducing the substance to be treated into the reaction field; (3) an oxygen deficiency-concentration portion formed in the crystal structure of ion conductor serving as the reaction field; (4) an electron-conducting phase that supplies electrons necessary for ionizing oxygen molecules adsorbed by the oxygen deficiency-concentration portion of the ion conductor, and (5) and an ion-conducting phase serving as a path for conveying the oxygen molecules ionized due to oxygen deficiency of the ion conductor to the outside of the reaction system. As a result, a chemical reactor can be constructed in which the substance to be treated is selectively adsorbed and decomposed in adsorption and decomposition reaction sites in separate adsorption and decomposition reaction sites with respect to the co-present oxygen molecules.

This chemical reactor will be described below in greater detail. In the aforementioned chemical reactor, the “basic units” necessary for the reaction of the substance to be treated include five elements as follows: (1) a fine particle structure of a transition metal that serves as a reaction field (for examples with respect to N of NO molecules); (2) a space for introducing the substance to be treated into the reaction field (nano space for simultaneously restricting the substance to be treated to the reaction field); (3) an oxygen deficiency-concentration portion formed in the crystal structure of ion conductor serving as the reaction field (for examples with respect to 0 of NO molecules); (4) an electron-conducting phase that supplies electrons necessary for ionizing oxygen molecules adsorbed by the oxygen deficiency-concentration portion of the ion conductors and (5) and an ion-conducting phase serving as a path for conveying the oxygen molecules ionized duo to oxygen deficiency of the ion conductor to the outside of the reaction system.

Here, the reason for using “transition metal” in (1) above is that the surface of transition metals has selective absorptivity with respect to covalent molecules. The “fine particle structure” is necessary to increase the adsorption reaction efficiency due to the increase in surface area. The “nano space” adjacent to the reduction phase in (2) above is necessary because, for example the size of space for rapidly inducing the adsorption reaction of NO molecules is restricted, whereas when the amount of substance to be treated (for example, automobile exhaust gases and the like) is large, a sufficient space is necessary to enable sufficient treatment. To meet these mutually contradictory requirements, a space of a nanometer scale is required. Examples of preferred types of such space include voids that get narrower from the outer side toward the inner side, and also a space, for example, in the form of a unidirectional through hole parallel to the flow path direction of exhaust gases or the like. As a result, the substance to be treated is caused to flow or diffuse into the nanometer-scale space and be adsorbed selectively by the oxygen deficiency-concentration portion of ion conductor, and chemical reaction on the reduction phase surface can be enhanced.

The oxygen deficiency-concentration portion of (3) above may be a substance or a structure having a capacity to adsorb oxygen and simultaneously or subsequently supply electrons for examples an oxide crystal having oxygen deficiency inside thereof and having a capacity to trap oxygen can be used. Those oxides that have electric conductivity are preferred as the substance supplying electrons. Further, an electric conductor or a structure obtained by tightly bonding and incorporating an electric conductor may be used as the electron-conducting phase of (4) above. Furthermore in (5) above, an ion conductor can be used independently as the conduction path for discharging oxygen ions to the outside of the system, but it is generally even more preferred that the ion conductor be integrated with the configuration of (3) above, or a structure or substance integrated with (4) above (the so-called mixed conductor) can be used. In accordance with the present invention, for examples fine particles of a transition metal, an ion conductor having an oxygen deficiency-concentration portions and an electron conductor are advantageously arranged as structural elements so that they constitute the above-described composition and structure. In this case, these constituent components are preferably disposed in the form of powders, but this form thereof is not limiting.

In the above-described chemical reactor, for example, when the substance to be treated is a nitrogen oxide contained in a combustion exhaust gasp the nitrogen oxide is reduced in the reduction phase, oxygen ions are generated, and the conduction of oxygen ions is induced in the ion conducting phases. No specific limitation is placed on the form of the chemical reactor, but advantageous examples thereof include pipes, plates, and honeycomb structures. In particular, it is preferred that a through hole having a pair of openings, or a plurality of such holes be provided, as in the pipe-like or honeycomb structure and that the chemical reaction unit be disposed in each through hole. Alternatively the flat plate configuration may be similarly advantageous if the chemical reaction unit is positioned on the surface of the plate, thereby providing a shape with as large a reaction surface area as possible.

The reduction phase in the chemical reaction unit is preferably a porous phase that selectively adsorbs the substance that is the reaction object. It is preferred that the reduction phase be composed of a conductive substance so as to supply electrons to the elements contained in the substance to be treated, generate ions, and transfer the generated ions to the ion conducting phase. Furthermore, it is even more preferred that the reduction phase be composed of a mixed conductive substance having both the electric conductivity and the ion conductivity, so as to enhance the transfer of electrons and ions, or be composed of a mixture of an electron conductive substance and an ion conductive substance.

No specific limitation is placed on these electrically conductive substance and ion conductive substance. Preferred examples of suitable electrically conductive substances include noble metals such as platinum and palladium, metal oxides such as nickel oxide, cobalt oxide, copper oxide, lanthanum manganite, lanthanum cobaltite, and lanthanum chromite, and also barium-containing oxides, and zeolites. It is preferred that at least one of these substances be used as a mixture with at least one ion-conducting substance. Furthermore, preferred examples of ion-conducting substances include zirconia stabilized with yttria or scandium oxide, ceria stabilized with gadolinium oxide or samarium oxide, and lanthanum gallate. The reduction phase is in contact with the electron conductor or at a nanometer-scale distance therefrom. The reduction phase that is in contact with the ion conductor has a volume that occupies the entire reduction phase portion preceding an ion conductor separate therefrom or portion thereof.

The ion conducting phase comprises a solid electrolyte having ion conductivity, preferably a solid electrolyte having oxygen ion conductivity. Examples of solid electrolytes having oxygen ion conductivity include zirconia stabilized with yttria or scandium oxide, ceria stabilized with gadolinium oxide or samarium oxide, and lanthanum gallate, but these examples are not limiting. It is preferred that zirconia stabilized with yttria or scandium oxide, which has nigh electric conductivity and strength and excels in long-term stability, be used as the ion conducting phase. Further, ceria-based solid electrolyte also can be advantageously used for applications where the utilization object thereof can be attained by a relatively rapid actuation.

The chemical reaction unit of the above-described configuration has a structure that enables highly efficiency adsorption and decomposition of the substance to be treated and also can simultaneously perform the adsorption of oxygen molecules and the adsorption and decomposition of the substance to be treated by separate substances suitable for each reaction. Thus, the metal phase that is generated by reduction of oxides or that was initially contained in the material (preferably in the form of ultrafine partials (diameter 10 to 100 nm) to attain high reactivity) and an oxygen deficiency-concentration portion (a region of about 5 nm as an estimated value calculated by the Debye length) of the on-conducting phase located in the vicinity of the metal phase are in contact with one another and ultrafine spaces with a size of from several to several hundred nanometers are co-present around the contact zone, whereby oxygen molecules located. In the introduced gas to be treated are selectively adsorbed and decomposed in the oxygen deficiency-concentration portion and the substance to be treated is selectively adsorbed and decomposed in the metal phase. As a result, power consumption can be greatly reduced.

The structure of such chemical reaction unit is formed by a heat treatment process (heat treatment in the atmosphere at 1400 to 1450° C. in a zircon a nickel oxide system) and by additional conduction treatment to the chemical reaction system or heat treatment in a reducing atmosphere or the like. Thus, for example, the reduction phase is formed by using an oxide that is comparatively easy to reduce and forming a reduction phase by conduction at a high temperature of not less than several 100° C. Due to volume changes of the crystal change caused by the redox reaction in this process, a microstructure is formed that is suitable for high-efficiency reaction for example, voids with a nanometer to micrometer size that are suitable for introducing the gas to be treated are formed, recrystallization of the reduction phase causes formation of ultrafine particles, and an oxygen deficiency-concentration portion of the ion conducting phase is formed via the redox reaction.

In a chemical reaction system of a conventional electrochemical cell type, a basic structure for enhancing the chemical reaction electrically comprises two electrodes (cathode and anode) that sandwich a solid electrolyte or has catalytic functions imparted to one of the electrodes A specific feature of the above-described chemical reactor is that such a structure forming an electric circuit as a whole is not necessary at all, and in order to activate a local structure where the reaction proceeds, it is essentially necessary to provide only a combination of an ion conductor and a reduction phase at a lowermost level.

With the above-described chemical reactor, by employing such a microstructure it is possible to provide different reaction sites for the reactions that proceed simultaneously or parallel to each other and concurrently within a short interval between atoms, molecules, or compounds of two or more kinds as reaction fields of chemical reactions such as reduction decomposition of nitrogen oxides thereby increasing selectivity of reaction and thus making it possible to increase greatly the reaction efficiency. By contrast, in the conventional chemical reactors such reactions could proceed only in the reaction sites (reaction active points) identical to those of decomposition reaction of oxygen molecules.

A combination of an ion-conducting phase and an electron-conducting phase and a combination of mixed conducting phases or such phases with an ion-conducting phase and an electron-conducting phase can be used as substances constituting such structures. For example, when a substance to be treated is nitrogen oxides a metallic phase such as nickel is more preferred as the reducing phase because it demonstrates selective absorptivity. By bringing a reducing phase into contact with an ion conductors for examples when a substance to be treated is nitrogen oxide, it is possible to perform more effectively the adsorption of nitrogen atoms contained in the nitrogen oxide by the reducing phase and the adsorption of oxygen atoms due to oxygen deficiency of ion conductor Accordingly, a structure is preferred in which the aforementioned constituent components are in the form of particles and which generally has a reducing phase in the form of a powder and an equally large number of ion conductors generally in the form of particles, wherein a larger amount of the substance to be treated can be brought into contact both with the reducing phase and the ion conductor with a higher degree of simultaneousness.

The chemical reaction device in accordance with the present invention will be described below in greater details. In accordance with the present invention, a ceramic chemical reaction device is formed from a structure in which a noble metal electrode such as platinum electrode is formed to pass electricity at a high temperature on a zirconium oxide or cerium oxide ceramic substrate that is an oxygen ion conductor, and also calcium aluminate serving as a combustion catalyst for solid carbon or nickel oxide serving as nitrogen oxide reduction catalyst are provided in order to attempt simultaneous decomposition of nitrogen oxide and solid carbon in the ceramic chemical reaction device in accordance with the present invention, a study was conducted in which a powder for solid carbon was fused onto the ceramic reaction device, electrolysis was conducted in a high-temperature atmosphere, and the solid carbon was burned in the ceramic chemical reaction device by supplying electric current. The results obtained demonstrated that electrolysis at 500° C. enables direct electrochemical decomposition and removal of carbon present on the surface Further it was found that where nitrogen oxide (NOx) is present, the solid carbon and nitrogen oxide are electrochemically decomposed at the same time.

The ceramic chemical reaction device in accordance with the present invention was then used to attempt simultaneous decomposition of hydrocarbons and nitrogen oxide in a ceramic chemical reaction device. Electrolysis was performed with a flow of nitrogen oxide and a hydrocarbon (ethane). The results obtained confirmed that decomposition of nitrogen oxide to nitrogen and decomposition of hydrocarbon to carbon dioxide proceed simultaneously due to electrochemical intake and release of oxygen in the ceramic chemical reaction device. By using the chemical reaction device in accordance with the present invention, it is possible to remove, for example, solid carbon such as PM, nitrogen oxides, and incombustible hydrocarbons contained in automobile exhaust gases and the like.

There is a particularly urgent necessity to decrease the amount and remove hazardous substances such as nitrogen oxides, carbon-containing particles, hydrocarbons and carbon monoxide present in diesel exhaust cases as means for treating exhaust gases of automobiles. With the conventional methods, for example, gaseous substances such as hydrocarbons, carbon monoxide, and nitrogen oxides are decomposed by using active catalysts such as metal ternary catalysts, and when carbon-containing particles (PM) are present, they are separated and removed physically with a filter and then subjected to subsequent processing. In the case of removal with a filter, problems are associated with replacement and cleaning of the filter, and improvements are required from the standpoint of treatment efficiency and cost. By contrast, in accordance with the present invention, nitrogen oxide present in exhaust gases is reduction decomposed and, at the same time, solid carbon and hydrocarbons with a high molecular weight, which are difficult to burn, can be directly oxidized and removed by effectively using oxygen ions generated in the reduction reaction. The present invention is especially very effective as purification means that can efficiently remove hazardous substances contained in exhaust gases where solid carbon is present.

A chemical reaction device that can electrochemically directly oxidize and remove solid carbon (PM) contained in exhaust gases, such as the device in accordance with the present invention, has not been heretofore reported, and the present invention is the very first disclosure of such a device. Further, using oxidizing agent—calcium aluminate (CaₓAl_{y}O_{z}) as a catalyst electrode also has not been heretofore reported, and the present invention is the very first disclosure of such use. The inventors confirmed that such catalyst electrode is greatly superior to the well-known noble metal catalysts. The present invention provides a novel ceramic chemical reaction device capable of decomposing solid carbon in which oxygen ions generated by reduction decomposition, e.g. of nitrogen oxide contained in exhaust gases is pulled by pumping into an ion-conducting ceramic material of a substrate, and solid carbon or the like is electrochemically directly oxidized and removed by using the oxygen ions, and such a device has not been heretofore suggested.

Thus, the present invention can provide a chemical reaction device comprising a novel chemical reaction system that can purify, for examples hazardous substances contained in exhaust gases with low energy consumption by supplying an electric current to the ceramic reaction device and simultaneously inducing different reactions, namely, an oxidation reaction in one location and a reduction reaction in another location of the chemical reaction device. The ion-conducting ceramic material of a substrate and the type and form of a catalyst electrode formed on the substrate, or the type and form of the cathode, solid electrolyte, and anode, these components constituting the chemical reaction device, can be designed arbitrarily according to the utilization object, type, and size of the chemical reaction device, and the present invention places no specific limitation on specific configurations thereof.

The present invention makes it possible to obtain the following significant effects: (1) a ceramic chemical reaction device capable of decomposing solid carbon can be provided which has a chemical reaction mechanism combining an oxygen ion-conducting ceramic such as zirconium oxide and cerium oxide, an electrode material such as platinum, and a catalyst material such as calcium aluminate and nickel oxide; (2) in this chemical reaction device, solid carbon particulate matter, hydrocarbons, and nitrogen oxides can be decomposed electrochemically in a continuous mode; (3) the chemical reaction device can be used, e.g. for purifying high-temperate exhaust gases such as automobile exhaust gases and decomposing volatile organic compounds (VOC); (4) with the ceramic chemical reaction device in accordance with the present invention, the oxidation reaction and reduction reaction proceed electrochemically, simultaneously and continuously. Therefore, the device in accordance with the present invention can be also used as a chemical reactor for performing oxidation-reduction reactions.

### BRIE DESCRIPTION OF THE DRAWINGS

FIG. 1 is a schematic drawing of a ceramic chemical reaction device capable of decomposing solid carbon in accordance with the present invention;

FIG. 2 shows photos of solid carbon on a substrate before and after electrolysis at 550° C. in the ceramic chemical reaction device capable of decomposing solid carbon in accordance with the present invention;

FIG. 3 shows results of simultaneous decomposition (relationship between the applied voltage, nitrogen oxide decomposition rate, and amount of generated carbon dioxide) of solid carbon and nitrogen oxide in the ceramic chemical reaction device capable of decomposing solid carbon in accordance with the present invention; and

FIG. 4 shows results of simultaneous decomposition (relationship between the applied voltage, nitrogen oxide decomposition rate, and amount of generated carbon dioxide) of hydrocarbon and nitrogen oxide in the ceramic chemical reaction device capable of decomposing solid carbon in accordance with the present invention.

### BEST MODE FOR CARRYING OUT THE INVENTION

The present invention is described below in greater detail by examples thereof, but the present invention is not limited to these examples.

### Example 1

### Fabrication of Ceramic Chemical Reaction Device

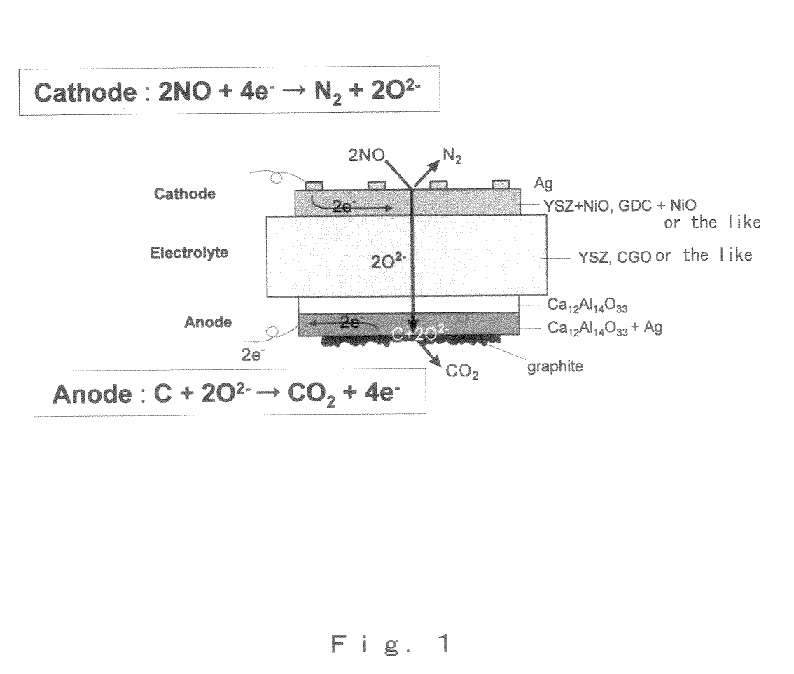

A commercial platinum paste (TR-707, manufactured by Tanaka Precious Metals Co. Ltd.) was screen printed as a catalyst material on an ion-conducting ceramic substrate (diameter 20 mm) comprising zirconium oxide and cerium oxide and having a thickness of 0.2 to 0.5 mm and dried for one hour a 150° C., then calcined for two hours at 950° C. to form platinum electrodes in two locations or both surfaces). The electrode surface had a diameter of 10 mm and the electrode film thickness was 100 μm. Furthermore, the platinum electrode was mesh-like printed to ensure direct contact of the ion-conducting substrate and the catalyst material. Further, on the surface of the platinum electrode, a paste-like composition was screen printed so as to cover the platinum electrode. The paste-like composition was prepared by mixing CaCO₃ and γ-Al₂O₃ (Ca:Al=12:14) at a predetermined ratio, calcining at a temperature of 1000° C. under an oxygen flow to synthesize calcium aluminate (Ca₁₂Al₁₄O₃₃), then grinding in a planetary ball mill to obtain a calcium aluminate powder, and combining the powder with a solvent such as polyethylene glycol. The coating film thickness in this process was about 100 μm. Then, nickel oxide and zirconium oxide were mixed at a predetermined ratio (Ni:Zr=50:50), and a paste was obtained with a solvent such as polyethylene glycol. The paste was screen printed in the same manner as described above. The printed paste was calcined at 1000 to 1500° C. onto the electrode. FIG. 1 is a schematic drawing of the ceramic chemical reaction device capable of decomposing solid carbon.

### Example 2

### Continuous Decomposition of Solid Carbon in the Ceramic Chemical Reaction Device

A glassy carbon paste was coated by screen printing on calcium aluminate of an anode of the ceramic chemical reaction device manufactured in Example 1, and the coating was dried at 150° C. and calcined at 500° C. in air. The weight of the coated carbon was measured. A lead wire (platinum) for supplying electricity was then attached to the ceramic chemical reaction device, a mixed gas of nitrogen oxide (1000 ppm NO gas) and He was caused to flow at 50 mL/min in a quartz tube, heated at 500 to 550 in an electric furnace, and various electric currents (voltages) were supplied to study the weight reduction of carbon on the surface of the ceramic chemical reaction device. Further, in this process, nitrogen oxide was decomposed at the cathode of the ceramic chemical reaction device and the oxygen produced was used as an oxygen source. Further, the amount of nitrogen oxide that was simultaneously decomposed was measured with an NOx analyzer.

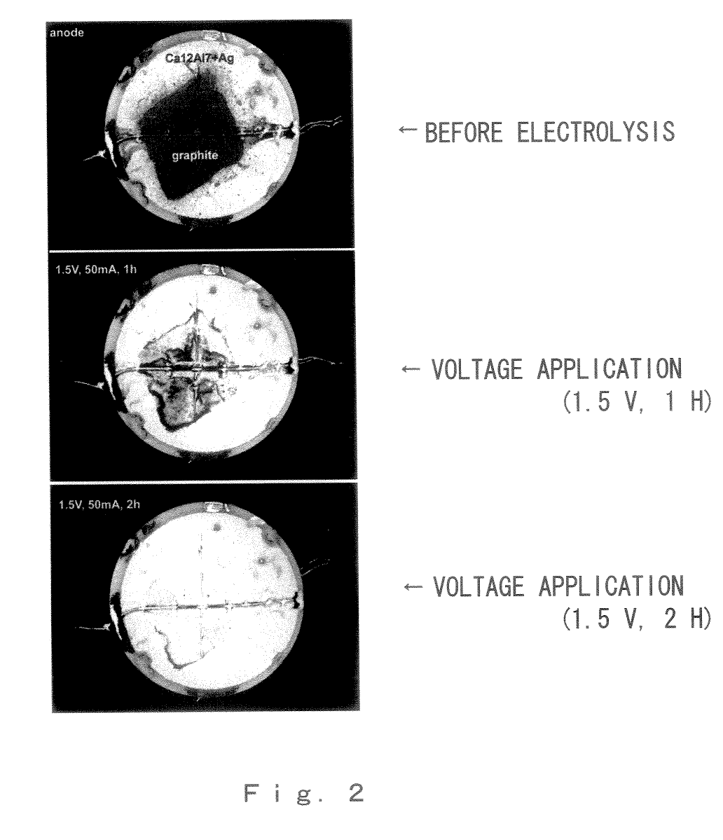

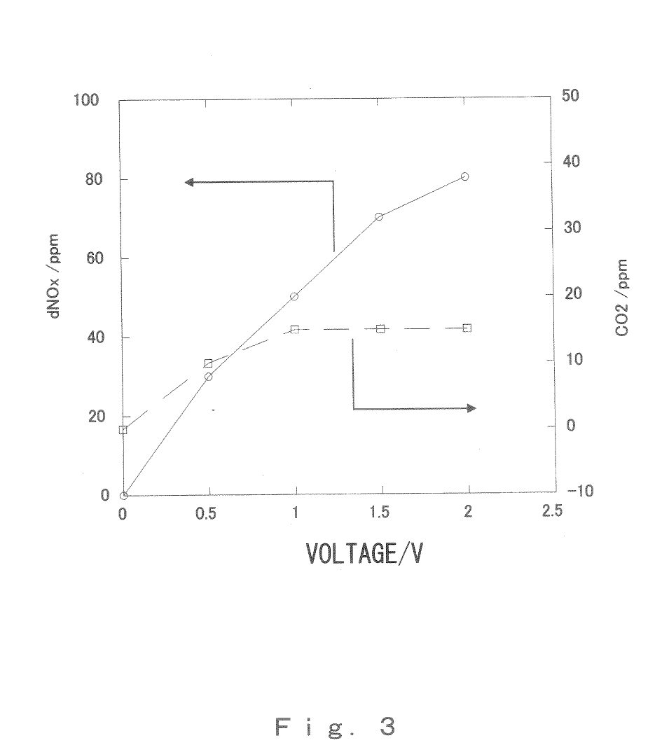

FIG. 2 shows photos of solid carbon on the substrate before and after electrolysis at 550° C. Before the electrolysis, carbon could not be removed despite the increase in temperature, but when electrolysis at 15 V was conducted for one to two hours, the entire solid carbon present on the surface could be removed. Furthermore, at this time, the co-present NOx could be simultaneously decomposed at 70 ppm by supplying the electric current (voltage). FIG. 3 shows simultaneous decomposition results of solid carbon and nitrogen oxide in the ceramic chemical reaction device capable of decomposing solid carbon (relationship between the applied voltage, amount of decomposed nitrogen oxide, and amount of generated carbon dioxide). Further, Table 1 (property comparison of silver, platinum and calcium aluminate catalysts) shows the results of electrochemical decomposition of solid carbon in the ceramic chemical reaction device at a temperature of 50° C. obtained with different oxidation electrode materials in the ceramic chemical reaction device. It was found that when calcium aluminate was used as the electrode material, the decomposition rate of solid carbon was the highest.

TABLE 1
Relation between oxidation electrode material and carbon
decomposition rate (500° C.)

| | Carbon decomposition rate |
|---|---|
| Electrode material | (mol/cm²-h) |
| Pt + 8YSZ (zirconia) | 0.3 × 10⁻⁵ |
| Ag + 8YSZ (zirconia) | 0.7 × 10⁻⁵ |
| Ca₁₂Al₁₄O₃₃ + 8YSZ (zirconia) | 1.3 × 10⁻⁵ |

### Example 3

### Simultaneous Decomposition of Hydrocarbon and Nitrogen Oxide in Ceramic Chemical Reaction Device

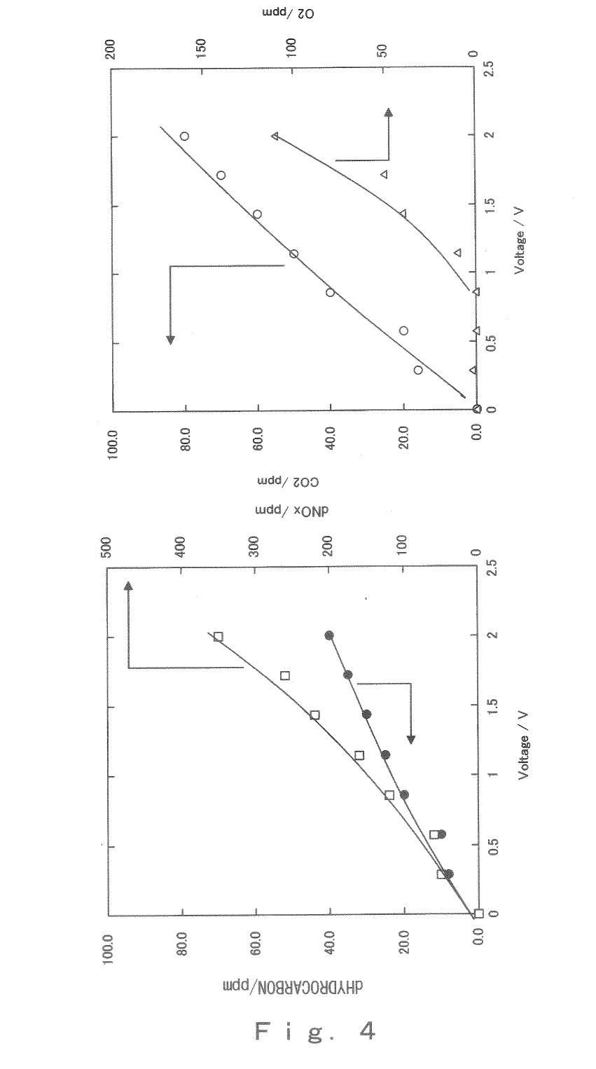

A mixed gas of a gaseous hydrocarbon (ethane) and nitrogen oxide was caused to low to a ceramic chemical reaction device used in Example 2, and the decomposition rate of the hydrocarbon and the amount of generated carbon dioxide under 0 to 2 V electrolysis in the ceramic chemical reaction device at 500° C. were studied. Furthermore, the decomposition rate of the nitrogen oxide Was studied. The results obtained are shown in FIG. 4 as simultaneous decomposition results (relationship between the applied voltage, nitrogen oxide decomposition rate, and amount of generated carbon dioxide) of hydrocarbon and nitrogen oxide in the ceramic chemical reaction device capable of decomposing solid carbon. When 500 ppm ethane and 1000 ppm NO flowed at a flow velocity of 50 mL/min, conducting 2 V electrolysis made it possible to decompose continuously 70 ppm ethane (14%) and, at the same times remove 200 ppm (20%) NO. Further, the generation of CO₂ and O₂ as products, following the decomposition of hydrocarbon and nitrogen oxide, was confirmed. The power consumption in the process was about 34 mW, and the decomposition was found to be possible at a very low power.

### INDUSTRIAL APPLICABILITY

As described hereinabove, the present invention relates to a ceramic chemical reaction device capable of decomposing solid carbons and the present invention can provide a chemical reaction device that can electrochemically directly oxidize and remove solid carbon (PM). Further, by using an oxidizing agent—calcium aluminate (CaₓAl_{y}O_{z}) as a catalyst electrodes it is possible to provide a chemical reaction device that is superior to that using a noble metal catalyst. The chemical reaction device in accordance with the present invention has a function of reduction decomposing nitrogen oxide and carbon dioxide contained in a gas phase and electrochemically directly oxidizing and removing solid carbon particulate matter hydrocarbons and carbon monoxide. Therefore, the device can be used, for example, for purifying high-temperature exhaust gases such as automobile exhaust gases and decomposing volatile organic compounds (VOC). Further, in the chemical reaction device in accordance with the present invention, the reduction reaction and oxidation reaction can be conducted electrochemically, simultaneously and continuously. Therefore, the present invention can be used, for example, as a chemical reactor for conducting oxidation-reaction reactions. The present invention can provide a ceramic chemical reaction device of a new type that can decompose nitrogen oxides and remove solid carbon simultaneously and continuously with extremely small power consumption.

1. A chemical reaction device having an ion-conducting ceramic material and a chemical reaction mechanism which comprises a catalyst electrode formed on said ceramic material and is capable of directly oxidizing and removing solid carbon (PM) electrochemically.

2. The chemical reaction device according to claim 1, wherein the ion-conducting ceramic material is a single-crystal or polycrystalline material in which a dissimilar element is solid-solution dissolved in a metal oxide.

3. The chemical reaction device according to claim 2, wherein the metal oxide is zirconium oxide, cerium oxide, gallium oxide, or bismuth oxide, and the dissimilar element is a rare earth metal or an alkaline earth metal.

4. The chemical reaction device according to claim 1, wherein the catalyst electrode comprises an oxide or a noble metal conductive material.

5. The chemical reaction device according to claim 1, having an action of directly oxidizing solid carbon (PM) into CO₂ and removing the same on the catalyst electrode.

6. The chemical reaction device according to claim 1, wherein an oxidizing agent and calcium aluminate are used as the catalyst electrode.

7. The chemical reaction device according to claim wherein electrodes are provided in two or more places and an electric current is supplied thereto.

8. A chemical reaction device that is a chemical reactor comprising a cathode, a solid electrolyte, and an anode, wherein solid carbon (M) is directly oxidized and removed by a reaction
C+2O²⁻→CO₂+4e⁻
by using oxygen ion supplied via the solid electrolyte on the anode surface.

9. The chemical reaction device according to claim 8, wherein a reduction reaction proceeds no the cathode, and an oxidation reaction proceeds on the anode.

10. The chemical reaction device according to claim 8, wherein on the cathode a nitrogen oxide and/or carbon dioxide present in the air is reduction decomposed, oxygen ions thus generated are supplied to the anode via the solid electrode, and hydrocarbons, carbon monoxide and/or solid carbon are directly electrochemically oxidized on the anode.

11. The chemical reaction device according to claim 1 or 8, which is a chemical reaction device for exhaust gas purification.

12. The chemical reaction device according to claim 1 or 8, which is a chemical reaction device for purification of volatile organic compounds.

13. An exhaust gas purification device comprising the chemical reaction device according to claim 1 or 8 and having a function of decomposing and removing hazardous substances by using a reduction reaction and/or an oxidation reaction of said chemical reaction device.

14. A gas-phase purification device comprising the chemical reaction device according to claim 1 or 8 and having a function of decomposing and removing volatile organic substances (VOC) in the gas phase by using a reduction reaction and/or an oxidation reaction of said chemical reaction device.

15. An exhaust gas purification device comprising a plurality of chemical reaction devices according to claim 1 or 8 in an exhaust gas channel.
